(19) United States
(12) Patent Application Publication
(10) Pub. No.: US 2013/0326391 A1
(43) Pub. Date: Dec. 5, 2013

(54) USER INTERFACE, METHOD FOR DISPLAYING THE SAME AND ELECTRICAL DEVICE

(71) Applicant: PEGATRON CORPORATION, Taipei City (TW)

(72) Inventors: Yu-Chang CHEN, TAIPEI CITY (TW); Mei-Chih CHEN, TAIPEI CITY (TW); Yi-Huan LEE, TAIPEI CITY (TW)

(73) Assignee: PEGATRON CORPORATION, TAIPEI CITY (TW)

(21) Appl. No.: 13/845,133

(22) Filed: Mar. 18, 2013

(30) Foreign Application Priority Data
May 31, 2012 (TW) 101119575

(51) Int. Cl. G06F 3/0481

(52) U.S. Cl. CPC G06F 3/0481
USPC 715/779

(57) ABSTRACT

A user interface includes a system status bar which is displayed on a desktop permanently. The system status bar includes an integrated toolbar which is displayed on the desktop through a touch panel sensing an input event. The integrated toolbar includes at least one workspace and an application launcher. The application launcher has at least one application icon for launching at least one application. Furthermore, a method for displaying a user interface and an electrical device are also disclosed herein.

### RELATED APPLICATIONS

This application claims priority to Taiwan Application Serial Number 101119575, filed May 31, 2012, which is herein incorporated by reference.

### BACKGROUND

1. Technology Field

The disclosure relates to an electrical digital data processing technique. More particularly, the disclosure relates to a user interface, a method for displaying the same and an electrical device.

2. Description of Related Art

The touch technology originated in the 1970's, but until 2007 when the Apple Inc. developed iPhone and iPod touch, a prevalence of touch aroused, and the touch technology then has been developed continuously to now. The touch technology enables an electrical device to be operated more simply and conveniently. An electrical device equipped with a touch panel can be almost operated in an intuitive manner, and thus the touch panel is applied widely in different kinds of electrical devices. Accordingly, more and more attentions are paid to a user interface related to the application of the touch panel.

With the development of science and technology, the information technology such as the application is developed vigorously, and thus the information required to be displayed on the user interface become more and more diverse. For example, application icons, search bars and specially-defined desktop tool widget gradually occupy the graphical space of the user interface while not all the aforesaid functions are common-use functions.

Furthermore, when the aforesaid functions are too much, these functions will be distributed on different desktops provided by the user interface, but this causes that when wanting to use a certain function, the user has to spend much time in searching the function. Furthermore, the user needs to return to the to desktop before performing some functions, being very inconvenient.

### SUMMARY

The invention aims to provide a user interface, a method for displaying the same and an electrical device, so as to solve the problem that when a user switches among functions provided by the electrical device, the functions should be first loaded onto the desktop, which is inconvenient for operations and is time-wasting.

For the aforesaid purpose, a technical aspect of the invention relates to a user interface. The aforesaid user interface is used in an electrical device equipped with a touch panel, wherein the touch panel displays a desktop of the electrical device. The user interface includes a system status bar which is displayed on a desktop permanently. The system status bar includes an integrated toolbar which is displayed on the desktop through a touch panel sensing an input event. The integrated toolbar includes at least one workspace and an application launcher. The application launcher has at least one application icon for launching at least one application.

According to an embodiment of the invention, the aforesaid integrated toolbar further includes a search box corresponding to searching among a network by entering text, applications of the electrical device or user e-mails. The aforesaid application launcher and search box are displayed at an upper position of the system status bar side by side.

According to another embodiment of the invention, the aforesaid integrated toolbar is transparent.

According to a further embodiment of the invention, the aforesaid system status bar further includes an integrated tool icon. The aforesaid first input event is an action of clicking the aforesaid integrated tool icon.

According to still a further embodiment of the invention, the aforesaid application launcher further includes an application adding icon for adding an application icon to the integrated toolbar through the touch panel sensing a second input event.

According to still yet a further embodiment of the invention, the aforesaid second input event is an action of clicking the application adding icon.

For the aforesaid purpose, another technical aspect of the invention relates to a method for displaying a user interface, which is applied in an electrical device equipped with a touch panel, wherein the aforesaid touch panel displays a desktop of the electrical device. The aforesaid method for displaying the user interface includes the following steps: displaying a system status bar on a desktop permanently; sensing a first input event through a touch panel; and displaying an integrated toolbar on the desktop, wherein the aforesaid integrated toolbar includes at least one workspace and an application launcher, and the aforesaid application launcher has at least one application icon for launching at least one application.

According to an embodiment of the invention, the aforesaid integrated toolbar further includes a search box corresponding to searching among a network by entering text, applications of the electrical device or user e-mails. The aforesaid application launcher and search box are displayed at an upper position of the system status bar side by side.

According to another embodiment of the invention, the aforesaid integrated toolbar is transparent.

According to a further embodiment of the invention, the aforesaid system status bar includes an integrated tool icon. The aforesaid first input event is an action of clicking the aforesaid integrated tool icon.

According to still a further embodiment of the invention, the aforesaid method for displaying the user interface further includes the following steps: sensing a second input event through the aforesaid touch panel; sensing a selection action to another application icon displayed on the desktop through the touch panel; sensing an action of dragging the aforesaid another application icon into the integrated toolbar through the touch panel; and adding the aforesaid another application icon to the integrated toolbar.

According to still yet a further embodiment of the invention, the aforesaid integrated toolbar includes an application adding icon. The aforesaid second input event is an action of clicking the aforesaid application adding icon.

According to an embodiment of the invention, the aforesaid method for displaying the user interface further includes the following steps: sensing an action of dragging the application icon in the integrated toolbar away from the integrated toolbar through the aforesaid touch panel; and removing the application icon from the integrated toolbar.

For the aforesaid purpose, a further technical aspect of the invention relates to an electrical device. The aforesaid electrical device includes a touch panel and a processor. The aforesaid touch panel displays a desktop of the electrical device. The aforesaid processor is used for performing a plurality of commands, and these commands include: displaying a system status bar on the aforesaid desktop permanently; sensing a first input event through the aforesaid touch panel; and displaying an integrated toolbar on the desktop, wherein the aforesaid integrated toolbar includes at least one workspace and an application launcher. The aforesaid application launcher has at least one application icon for launching at least one application.

According to an embodiment of the invention, the aforesaid integrated toolbar includes a search box corresponding to searching among a network by entering text, applications of the electrical device or user e-mails. The aforesaid application launcher and search box are displayed at an upper position of the system status bar side by side.

According to another embodiment of the invention, the aforesaid integrated toolbar is transparent.

According to a further embodiment of the invention, the aforesaid system status bar includes an integrated tool icon. The aforesaid first input event is an action of clicking the aforesaid integrated tool icon.

According to still a further embodiment of the invention, the aforesaid application launcher includes an application adding icon which adds an application icon to the aforesaid integrated toolbar through the aforesaid touch panel sensing a second input event.

According to still yet a further embodiment of the invention, the aforesaid second input event is an action of clicking the aforesaid application adding icon.

Therefore, according to the technical content of the invention, the embodiments of the invention provides the user interface, the method for displaying the same and the electrical device, being convenient for the user to perform a required function at real time by integrating common-use functions into the aforesaid integrated toolbar. Furthermore, a scheme is further provided to enable the user to add additional common-use functions into the integrated toolbar, which is convenient for the user to use and manage the integrated toolbar. Also, the integrated toolbar can be applied to integrate and arrange the unorderly functions in order, which not only simplifies the entire operation process and improves the use efficiency, but also makes the desktop be compact and convenient for the user to manage.

### BRIEF DESCRIPTION OF THE DRAWINGS

In order to make the foregoing as well as other aspects, features, advantages, and embodiments of the invention more apparent, the accompanying drawings are described as follows:

FIG. 1A illustrates a schematic view of a user interface according to an embodiment of the invention; and FIG. 1B illustrates a schematic view of a user interface according to another embodiment of the invention;

FIG. 2A illustrates a schematic view of an electrical device according to an embodiment of the invention: and FIG. 2B illustrates a schematic view of an electrical device according to another embodiment of the invention;

FIG. 3 illustrates a flow chart of a method for displaying a user interface according to an embodiment of the invention; and

FIG. 4 illustrates a flow chart of a method for displaying a user interface according to another embodiment of the invention.

### DETAILED DESCRIPTION

In order to make the description of the invention more detailed and more comprehensive, various embodiments are described below with reference to the accompanying drawings. The same reference numbers are used in the drawings to refer to the same or like elements. However, the embodiments described are not intended to limit the invention. Moreover, it is not intended for the description of operation to limit the order of implementation. Any device with equivalent functions that is produced from a structure formed by a recombination of elements shall fall within the scope of the invention.

The drawings are only illustrative and are not drawn to actual size. Additionally, well-known elements and steps are not described in the embodiments to avoid causing unnecessary limitations to the invention.

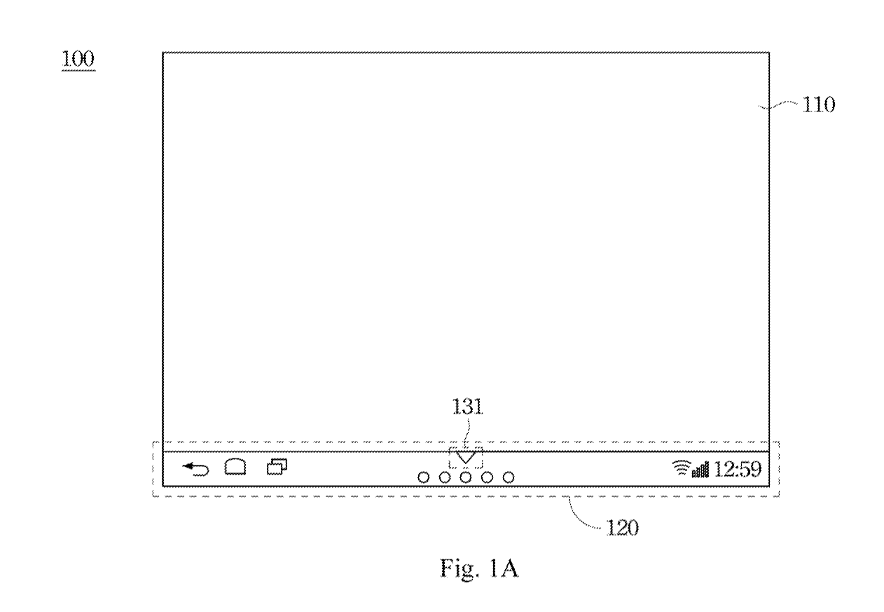

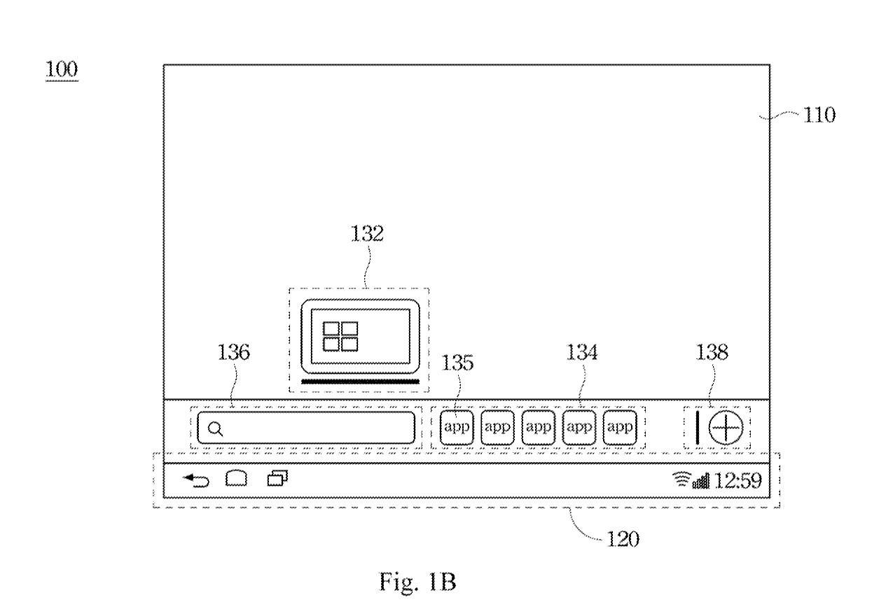

FIG. 1A illustrates a schematic view of a user interface according to an embodiment of the invention; and FIG. 1B illustrates a schematic view of a user interface according to another embodiment of the invention.

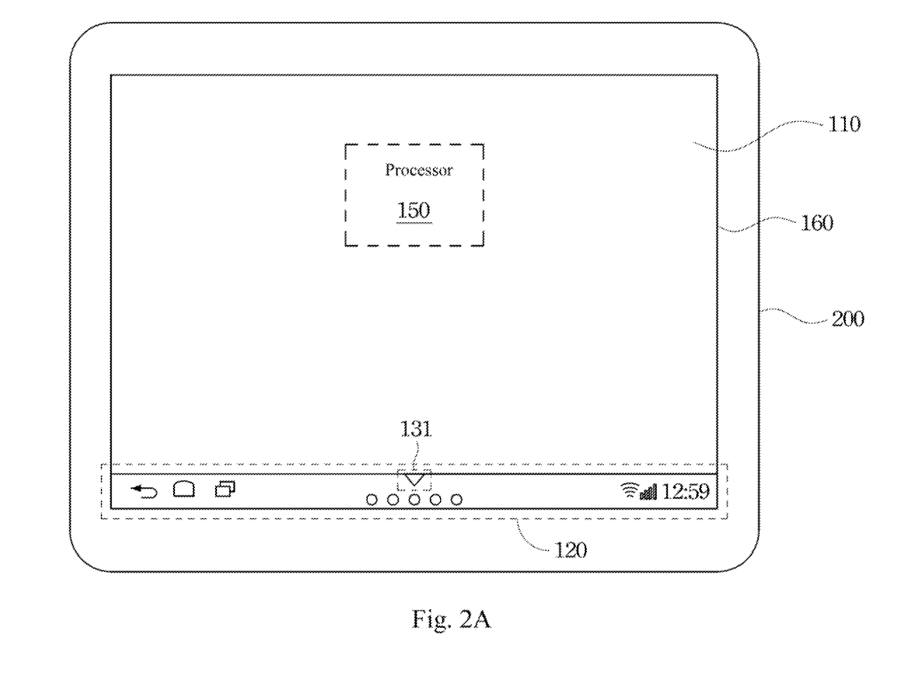

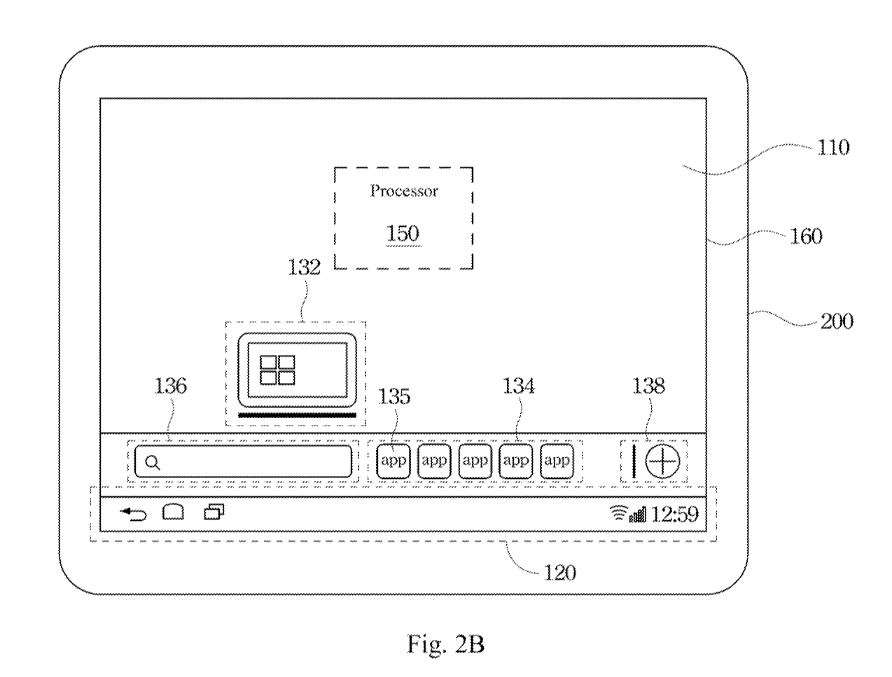

As shown in FIG. 1A, the user interface 100 is applied in an electrical device equipped with a touch panel (as shown in FIGS. 2A and 2B), and this touch panel displays a desktop 110 of the electrical device. The user interface 100 includes a system status bar 120 which is displayed on a desktop 110 permanently. The system status bar 120 includes an integrated toolbar which is displayed on the desktop 110 through the touch panel sensing a first input event.

Referring to FIG. 1B, the integrated toolbar includes at least one workspace 132 and an application launcher 134. The application launcher 134 has at least one application icon 135 for launching at least one application.

In view of the above, the user interface 100 according to the embodiment of the invention integrates the common-use workspace 132 and application launcher 134 into the integrated toolbar, so as to solve the problem that when a user switches among functions provided by the electrical device, the functions should be first loaded onto the desktop 110, which is inconvenient for operations and is time-wasting.

In another embodiment, as shown in FIG. 1B, the integrated toolbar further includes a search box 136 corresponding to searching among a network by entering text, applications of the electrical device or user e-mails. The aforesaid application launcher 134 and search box 136 are displayed at an upper position of the system status bar 120 side by side.

In an optical embodiment, the aforesaid integrated toolbar is transparent, and thus when the integrated toolbar is displayed on the desktop 110, the user can still view the desktop 110 through the transparent integrated toolbar to obtain the current position, which is convenient for the user to operate.

As shown in FIG. 1A, the system status bar 120 further includes an integrated tool icon 131. When the first input event is performed (i.e., after the user clicks the integrated tool icon 131), the integrated toolbar as shown in FIG. 1B is displayed on the desktop 110.

In a further embodiment, the integrated toolbar as shown in FIG. 1B further includes an application adding icon 138 which adds an application icon 135 to the integrated toolbar through the touch panel sensing a second input event.

For example when the second input event is performed (i.e., when the user clicks the application adding icon 138), the user can add the application icon 135 to the integrated toolbar.

In this view, the user interface 100 provided by the embodiments of the invention can integrate common-use functions into an integrated toolbar, which is convenient for the user to perform the required function at real time. Furthermore, a scheme is further provided to enable the user to add additional common-use functions into the integrated toolbar, which is convenient for the user to use and manage the integrated toolbar. Also, the aforesaid user interface 100 can be applied to integrate and arrange the unorderly functions in order, which not only simplifies the entire operation process and improves the use efficiency, but also makes the desktop be compact and convenient for the user to manage.

FIG. 2A illustrates a schematic view of an electrical device according to an embodiment of the invention: and FIG. 2B illustrates a schematic view of an electrical device according to another embodiment of the invention.

As shown in FIG. 2A, the electrical device 200 includes a touch panel 160 and a processor 150. The touch panel 160 displays the desktop 110 of the electrical device 200. Referring to both of FIGS. 2A and 2B, the processor 150 is used for performing a plurality of commands, wherein these commands include: displaying a system status bar on the desktop 110 permanently; sensing the first input event through the touch panel 160; and displaying the integrated toolbar on the desktop 110, wherein the aforesaid integrated toolbar includes at least one workspace 132 and an application launcher 134. The application launcher 134 has at least one application icon 135 for launching at least one application.

In view of the above, the electrical device 200 according to the embodiment of the invention integrates the common-use workspace 132 and application launcher 134 into the integrated toolbar, so as to solve the problem that when a user switches among functions provided by the electrical device, the functions should be first loaded onto the desktop 110, which is inconvenient for operations and is time-wasting.

In an embodiment, the aforesaid integrated toolbar includes a search box 136 corresponding to searching among a network by entering text, applications of the electrical device or user e-mails. The aforesaid application launcher 134 and search box 136 are displayed at an upper position of the system status bar 120 side by side.

In an optical embodiment, the aforesaid integrated toolbar is transparent, and thus when the integrated toolbar is displayed on the desktop 110, the user can still view the desktop 110 through the transparent integrated toolbar to obtain the current position, which is convenient for the user to operate.

As shown in FIG. 2A, the system status bar 120 includes an integrated tool icon 131. When the first input event is performed (i.e., after the user clicks the integrated tool icon 131), as shown in FIG. 2B, the integrated toolbar is displayed on the desktop 110 through the touch panel 160.

In another embodiment, the aforesaid application launcher 134 includes an application adding icon 138 which adds an application icon 135 to the aforesaid integrated toolbar through the aforesaid touch panel 160 sensing a second input event.

For example when the second input event is performed (i.e., when the user clicks the application adding icon 138), the user can add the application icon 135 to the integrated toolbar.

In this view, the electrical device 200 provided by the embodiments of the invention can perform different commands to display the integrated toolbar on the touch panel 160 thereof. This integrated toolbar integrates common-use functions therein, which is convenient for the user to perform the required function at real time. Furthermore, a scheme is further provided to enable the user to add additional common-use functions into the integrated toolbar, which is convenient for the user to use and manage the integrated toolbar. Also, the electrical device 200 can apply the integrated toolbar to integrate and arrange the unorderly functions in order, which not only simplifies the entire operation process and improves the use efficiency, but also makes the desktop of the electrical device 200 be compact and convenient for the user to manage.

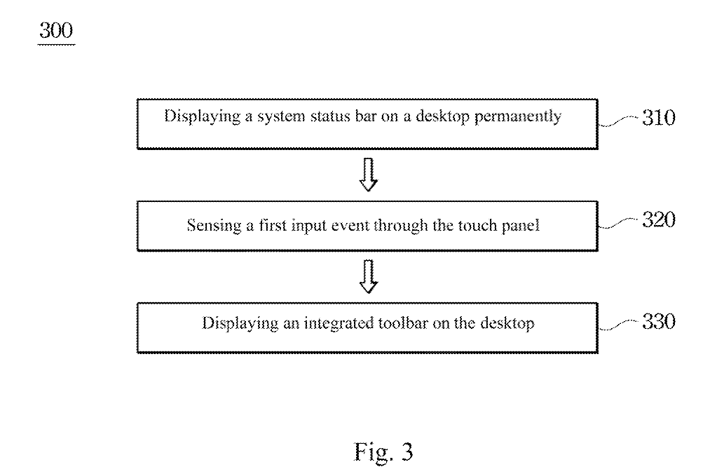

FIG. 3 illustrates a flow chart of a method for displaying a user interface) according to an embodiment of the invention. The shown method 300 for displaying a user interface is applied in an electrical device equipped with a touch panel, wherein the aforesaid touch panel displays the desktop of the electrical device. The aforesaid method 300 for displaying the user interface includes the following steps: displaying a system status bar on a desktop permanently (step 310); sensing a first input event through the touch panel (step 320); and displaying an integrated toolbar on the desktop, wherein the aforesaid integrated toolbar includes at least one workspace and an application launcher, and the aforesaid application launcher has at least one application icon for launching at least one application (step 330).

Reference is made to both of FIGS. 2B and 3. In step 310, a command is performed through a processor 150 to display the system status bar 120 on the desktop 110 permanently. In step 320, a first input event is sensed by the touch panel 160, and then in step 330, the integrated toolbar is displayed on the desktop 110 through the touch panel 160. The integrated toolbar includes at least one workspace 132 and an application launcher 134. The application launcher 134 has at least one application icon 135 for launching at least one application.

In an embodiment, the aforesaid integrated toolbar includes a search box 136 corresponding to searching among a network by entering text, applications of the electrical device or user e-mails. The aforesaid application launcher 134 and search box 136 may also be displayed at an upper position of the system status bar 120 side by side through the processor 150 performing a command.

In another embodiment, the aforesaid integrated toolbar is transparent, and thus when the integrated toolbar is displayed on the desktop 110, the user can still view the desktop 110 through the transparent integrated toolbar to obtain the current position, which is convenient for the user to operate.

Referring to both of FIGS. 2A and 3, the system status bar 120 includes an integrated tool icon 131. The aforesaid first input event is an action of clicking the aforesaid integrated tool icon 131.

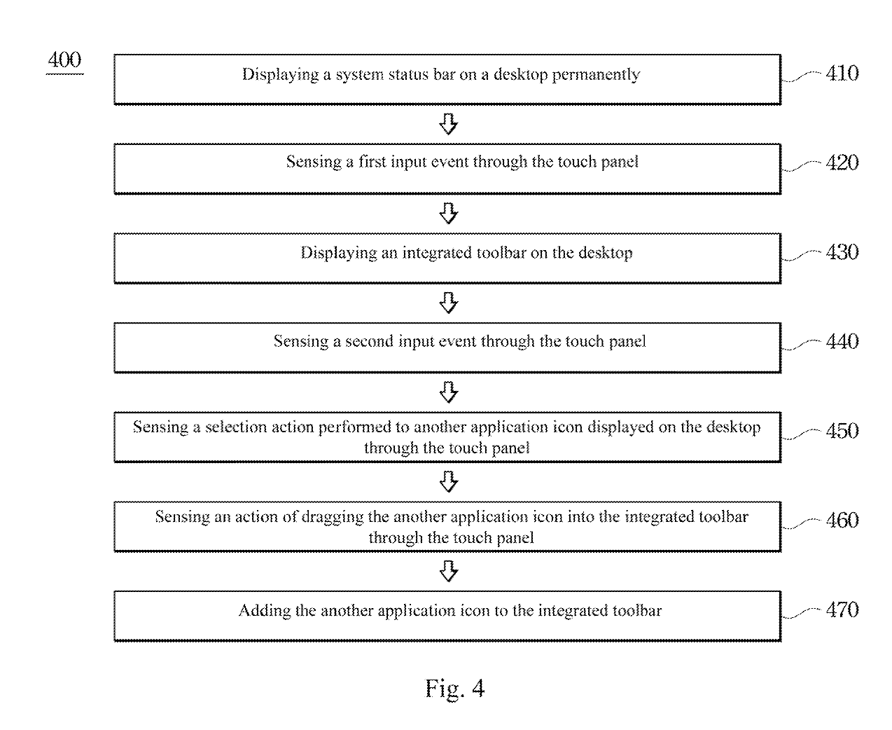

FIG. 4 illustrates a flow chart of a method for displaying a user interface according to another embodiment of the invention. The shown method 400 for displaying a user interface is applied in an electrical device equipped with a touch panel, wherein the aforesaid touch panel displays the desktop of the electrical device.

Compared with the method 300 for displaying the user interface, the method 400 for displaying the user interface further includes the following steps: sensing a second input event through the touch panel (step 440); sensing a selection action to another application icon displayed on the desktop through to the touch panel (step 450); sensing an action of dragging the aforesaid another application icon into the integrated toolbar through the touch panel (step 460); and adding the aforesaid another application icon to the integrated toolbar (step 470).

Reference is made to both of FIGS. 2B and 4. For example, when the user needs to add another application icon into the integrated toolbar, first the second input event is sensed by the touch panel 160; then another application icon is selected by the user and the aforesaid selection action is sensed through the touch panel 160; and subsequently the another application icon is dragged into the integrated toolbar by the user, and the action of dragging the another application icon is sensed by the touch panel 160, so that the aforesaid another application icon is added into the integrated toolbar.

Particularly, the aforesaid integrated toolbar includes an application adding icon 138 as shown in FIG. 2B. When the aforesaid second input event is performed (i.e., when the user clicks the application adding icon 138), the user can add the application icon into the integrated toolbar.

In an embodiment, referring to both of FIGS. 2B and 4, the method 400 for displaying the user interface further includes the following steps: sensing an action of dragging the application icon in the integrated toolbar away from the integrated toolbar through the aforesaid touch panel; and removing the application icon from the integrated toolbar.

For example, when the user needs to remove the application icon from the integrated toolbar, the user drags a certain application icon away from the integrated toolbar, and the aforesaid action of dragging is sensed by the touch panel 160, and subsequently the aforesaid application icon is removed from the to integrated toolbar.

In this view, the methods 300 and 400 for displaying the user interface provided by the embodiments of the invention can display the integrated toolbar on the desktop. This integrated toolbar integrates common-use functions therein, which is convenient for the user to perform the required function at real time. Furthermore, a scheme is further provided to enable the user to add additional common-use functions into the integrated toolbar, which is convenient for the user to use and manage the integrated toolbar. Also, the methods 300 and 400 for displaying the user interface can apply the integrated toolbar to integrate and arrange the unorderly functions in order, which not only simplifies the entire operation process and improves the use efficiency, but also makes the desktop be compact and convenient for the user to management.

The aforesaid methods for displaying the user interface can be performed through a software, hardware and/or firmware. For example, if the performance speed and accuracy are considered primarily, substantially the hardware and/or firmware can be selected as the major; if the design flexibility is considered primarily, substantially the software can be selected as the major; or alternatively the software, hardware and firmware can operate cooperatively. It should be understood that the aforesaid examples have no priority and are not intended to limit the invention, and those of skills can design flexibly according to the requirement.

Furthermore, those of ordinary skills in the art should understand that steps of the methods for displaying the user interface are named according to the functions thereof, which are only used to make the technique of the invention more apparent and clear and are not intended to limit these steps. Integrating the steps into one step or separating one step into multiple steps, or inserting any step into another step still belong to the embodiments of the invention.

It can be seen from the aforementioned embodiments of the invention that the invention has the following application advantages. The invention provides a user interface, a method for displaying the same and an electrical device, so as to solve the problem that when a user switches among functions provided by the electrical device, the functions should be first loaded onto desktops, being inconvenient for operation and is time-wasting.

Furthermore, the embodiments of the invention integrate common-use functions into the aforesaid integrated toolbar, which is convenient for the user to perform the required function at real time. Furthermore, a scheme is further provided to enable the user to add additional common-use functions into the integrated toolbar, which is convenient for the user to use and manage the integrated toolbar. Also, the integrated toolbar can be applied to integrate and arrange the unorderly functions in order, which not only simplifies the entire operation process and improves the use efficiency, but also makes the desktop be compact and convenient for the user to management.

Although the invention has been disclosed with reference to the above embodiments, these embodiments are not intended to limit the invention. It will be apparent to those of skills in the art that various modifications and variations can be made without departing from the spirit and scope of the invention. Therefore, the scope of the invention shall be defined by the appended claims.

What is claimed is:

1. A user interface used in an electrical device equipped with a touch panel, wherein the touch panel displays a desktop of the electrical device, and the user interface comprises:
a system status bar displayed permanently on the desktop, comprising:
an integrated toolbar displayed on the desktop through the touch panel sensing a first input event, comprising:
at least one workspace; and
an application launcher having at least one application icon for launching at least one application.

2. The user interface of claim 1, wherein the integrated toolbar further comprises a search box corresponding to searching among a network by entering text, applications of the electrical device or user e-mails, and the application launcher and the search box are displayed at an upper position of the system status bar side by side.

3. The user interface of claim 1, wherein the integrated toolbar is transparent.

4. The user interface of claim 1, wherein the system status bar further comprises an integrated tool icon, and the first input event is an action of clicking the integrated tool icon.

5. The user interface of claim 1, wherein the application launcher further comprises an application adding icon which adds an application icon to the integrated toolbar through the touch panel sensing a second input event.

6. The user interface of claim 5, wherein the second input event is an action of clicking the application adding icon.

7. A method for displaying a user interface, applied in an electrical device equipped with a touch panel, wherein the touch panel displays a desktop of the electrical device, and the method for displaying the user interface comprises:
displaying a system status bar permanently on the desktop,
sensing a first input event through the touch panel; and
displaying an integrated toolbar on the desktop, wherein the integrated toolbar comprises at least one workspace and an application launcher, and the application launcher has at least one application icon for launching at least one application.

8. The method for displaying the user interface of claim 7, wherein the integrated toolbar further comprises a search box corresponding to searching among a network by entering text, applications of the electrical device or user e-mails, and the application launcher and the search box are displayed at an upper position of the system status bar side by side.

9. The method for displaying the user interface of claim 7, wherein the integrated toolbar is transparent.

10. The method for displaying the user interface of claim 7, wherein the system status bar further comprises an integrated tool icon, and the first input event is an action of clicking the integrated tool icon.

11. The method for displaying the user interface of claim 7, further comprising:
sensing a second input event through the touch panel;
sensing a selection action to another application icon displayed on the desktop through the touch panel;
sensing an action of dragging the another application icon into the integrated toolbar through the touch panel; and
adding the another application icon into the integrated toolbar.

12. The method for displaying the user interface of claim 11, wherein the integrated toolbar comprises an application adding icon, and the second input event is an action of clicking the application adding icon.

13. The method for displaying the user interface of claim 7, further comprising:
sensing an action of dragging the application icon in the integrated toolbar away from the integrated toolbar through the touch panel; and
removing the application icon from the integrated toolbar.

14. An electrical device, comprising:
a touch panel displaying a desktop of the electrical device;
a processor for performing a plurality of commands, wherein the commands comprise:
displaying a system status bar permanently on the desktop;
sensing a first input event through the touch panel;
displaying an integrated toolbar on the desktop, wherein the integrated toolbar comprises at least one workspace and an application launcher, and the application launcher has at least one application icon for launching at least one application.

15. The electrical device of claim 14, wherein the integrated toolbar comprises a search box corresponding to searching among a network by entering text, applications of the electrical device or user e-mails, and the application launcher and the search box are displayed at an upper position of the system status bar side by side.

16. The electrical device of claim 14, wherein the integrated toolbar is transparent.

17. The electrical device of claim 14, wherein the system status bar comprises an integrated tool icon, and the first input event is an action of clicking the integrated tool icon.

18. The electrical device of claim 14, wherein the application launcher comprises an application adding icon which adds an application icon into the integrated toolbar through the touch panel sensing a second input event.

19. The electrical device of claim 14, wherein the second input event is an action of clicking the application adding icon.
